(19) United States
(12) Patent Application Publication
(10) Pub. No.: US 2007/0125944 A1
(43) Pub. Date: Jun. 7, 2007

(54) HORN MASS SPECTROMETER USING DIGITAL DEFLECTION DRIVE

(76) Inventor: James G. Hagerman, Honolulu, HI (US)

Correspondence Address: LEIGHTON K. CHONG;PATENT ATTORNEY, 133 KAAI STREET, HONOLULU, HI, 96821, US

(21) Appl. No.: 11/536,636

(22) Filed: Sep. 28, 2006

Related U.S. Application Data
(63) Continuation-in-part of application No. 11/297,238, filed on Dec. 7, 2005.

(51) Int. Cl. H01J 49/42

(52) U.S. Cl. 250/292

(57) ABSTRACT

A digital deflection drive is provided for handling the ion beam input of a rotating electric field ion mass spectrometer (REFIMS), and specifically, a hyperbolic helical horn mass spectrometer (3HMS). In preferred form, the digital deflection drive generates square waves which are easier to implement with digital electronics and also consumes lower power, as compared to an analog (sine wave) drive. The electronic drive circuitry can be implemented by a microprocessor, field programmable gate array (FPGA), or simple logic circuits. In an example for an octopole configuration, the electronic drive circuitry is implemented by logic reduction using three levels of divide-by-two flip-flop stages. In a quadrapole configuration, it can be implemented as a tri-level voltage drive with binary logic circuits

This U.S. Patent Application is a continuation-in-part of co-pending U.S. patent application Ser. No. 11/297,238 of the same inventor filed on Dec. 7, 2005, entitled “Hyperbolic Horn Helical Mass Spectrometer”

### TECHNICAL FIELD

This invention generally relates to an improvement for a rotating electric field ion mass spectrometer (REFIMS), and more particularly, to one which reliably handles the ion input beam with relatively simple and inexpensive electronic drive circuitry.

### BACKGROUND OF INVENTION

A prior type of rotating electric field ion mass spectrometer (REFIMS) has an analyzer cell configured with an entrance end, four spaced-apart longitudinal walls to which time-dependent phased RF potentials are applied, and a detector at its target end. This type of REFIMS cell is described in U.S. Pat. No. 5,726,448 issued on Mar. 10, 1998, to S. J. Smith and A. Chutjian, which is incorporated by reference. The time-dependent RF potentials applied to the cell walls create an RF field which effectively rotates the ion beam within the cell. As the ions of the beam are rotated into a spiral path in the cell, the rotating RF field disperses the ion beam according to the mass-to-electrical charge (m/e) ratio and velocity distribution present in the ion beam. The ions of the beam are deflected angularly on the target detector, depending on the m/e, RF amplitude, and RF frequency. The detector counts the incident ions to determine the m/e and velocity distribution of ions in the beam, thereby providing a profile of the elemental constituents in the beam. One possible advantage of this type of device is that the spectral readout can be developed over a two-dimensional detector plane, which provides enhanced profile information for analysis as compared to the conventional one-dimensional (spot or line) spectral readouts. Further descriptions of this type of system are provided in: Clemmons, J. H., 1992, “Sounding rocket observations of precipitating ions in the morning auroral region”, Ph. D. dissertation, Univ. California, Berkeley, 135 pp; and Clemmons, J. H., and Herrero, F. A., 1998, “Mass spectroscopy using a rotating electric field”, Rev. Sci. Instruments 69, 2285-2291.

Unfortunately, the REFIMS device heretofore has had severe inherent problems relating to ion entrance angle and sensitivity that have made it practically unusable. The abrupt transition from free-space to the RF electric field between the grids requires that the ion entrance angle, offset, and timing coincide with the resonant helical path at an exact RF phase. Looked at in reverse, a resonant ion beam exiting the grids would travel out at a particular angle and offset radius, in contrast to the incident beam direction along the central longitudinal axis. Constructing a device with these limitations is possible, but the loss of sensitivity is remarkable. Only ions entering the chamber at the exact RF phase will resonate, all others are rejected, even if of the correct mass. If this tolerance is off by +/−1 degree, it means a sensitivity loss of 180 times, even before filtering takes place.

In my co-pending U.S. patent application Ser. No. 11/297,238, an improved rotating electric field ion mass spectrometer provides for a smooth transition for the input ion beam for the electric field strength in the cell by starting the field strength impact on the ion helical radius at zero and smoothly increasing it to the desired value for rotating the beam. This is accomplished by modifying the grid shape at the entrance from a fixed-diameter tunnel to that of a horn. Looking like the bell of a trumpet, the horn shape has a flare end with a larger entrance width that reduces the grid electric field strength to near zero and causes no abrupt deflection of the beam at the entrance, and tapers along the longitudinal z axis to a narrower width so that the field strength applied to the beam increases gradually until the correct angle, offset, and timing are obtained at its exit end for driving the beam into the desired rotation for the REFIMS device. Preferably, the horn shape in cross-section is hyperbolic, and the field strength increases linearly with distance along the z axis. My prior U.S. patent application Ser. No. 11/297,238 is incorporated by reference herein in its entirety.

The hyperbolic helical horn mass spectrometer (3HMS) has hyperbolic wall surfaces for the deflection electrodes. FIG. 1A shows a schematic side view of a 3HMS unit housed within a vacuum chamber, and FIG. 1B shows an end-on cross-sectional view showing the electric field lines generated by an octopole 3HMS prototype. Cylindrically symmetric, an octopole horn structure is split into eight sections driven by RF sine wave voltages on the deflection grids. The double integration from force (acceleration) to velocity to position is inherently simple with sine waves, as the solution is just another sine wave (with phase change). However, symbolic integration of nonlinear waveforms applied to eight deflection electrodes is more difficult, if not impossible, to achieve. Since the frequency must be variable in order to scan a spectrum, the deflection drive for a multipole 3HMS unit requires relatively complex and costly circuitry. It would be desirable to provide a deflection drive for the 3HMS unit implemented with relatively simple and inexpensive electronic drive circuitry.

### SUMMARY OF INVENTION

In accordance with the present invention, a novel digital (square wave) deflection drive, as contrasted to analog (sine wave) deflection drive, is provided for handling the ion beam input of a rotating electric field ion mass spectrometer (REFIMS), and specifically, a hyperbolic helical horn mass spectrometer (3HMS). The square or digital wave drive is much easier to implement with digital electronics, and also consumes lower power.

### BRIEF DESCRIPTION OF DRAWINGS

FIG. 1A shows a schematic side view of a preferred embodiment of a hyperbolic helical horn mass spectrometer (3HMS) unit housed within a vacuum chamber, and FIG. 1B shows an end-on cross-sectional view showing the electric field lines generated by an octopole 3HMS prototype.

FIG. 2 shows integration waveforms for a square wave, digital deflection drive for an octopole 3HMS unit illustrating force, velocity, and position.

FIG. 3 shows a simulation of integration waveforms for a quadrapole configuration of the deflection electrodes.

FIG. 4 illustrates schematically the output of a basic tri-level voltage drive.

FIG. 5 illustrates an example of a binary logic circuit for a basic tri-level voltage drive.

FIG. 6 illustrates an octopole electrode arrangement as an example.

FIG. 7 shows the field amplitude cycle along any given electrode axis for the octopole configuration

FIG. 8 illustrates the combinational logic relationship between octopole phases.

FIG. 9 illustrates a simple circuit for three-state logic reduction for generating the octopole phases.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

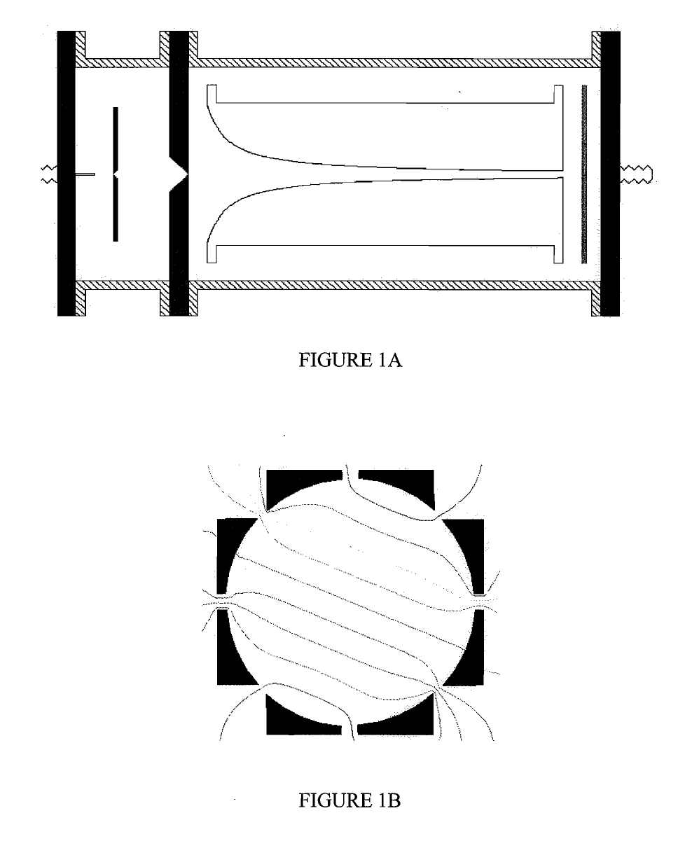

An example of a digital deflection drive will now be described to generate the desired electrical field for deflecting the trajectory of an ion beam in a rotating electric field ion mass spectrometer (REFIMS), and specifically, a hyperbolic helical horn mass spectrometer (3HMS). In the preferred embodiment, the 3HMS unit has an octopole deflector electrode configuration. The deflection drive applies phased square wave waveforms to the deflection electrodes. An electric field is generated using a positive voltage on three adjacent grids, an equal but negative voltage on the opposite three, and zero volts on the remaining two. The electric field isopotential lines thus generated are intended to be the same or similar as that shown in FIG. 1B. There are eight possible angular rotations. That is, the field can be stepped in 45-degree increments. The normalized electric field force on an ion along an axis is then either sin(0)=0, sin(45)=0.707, and sin(90)=1.

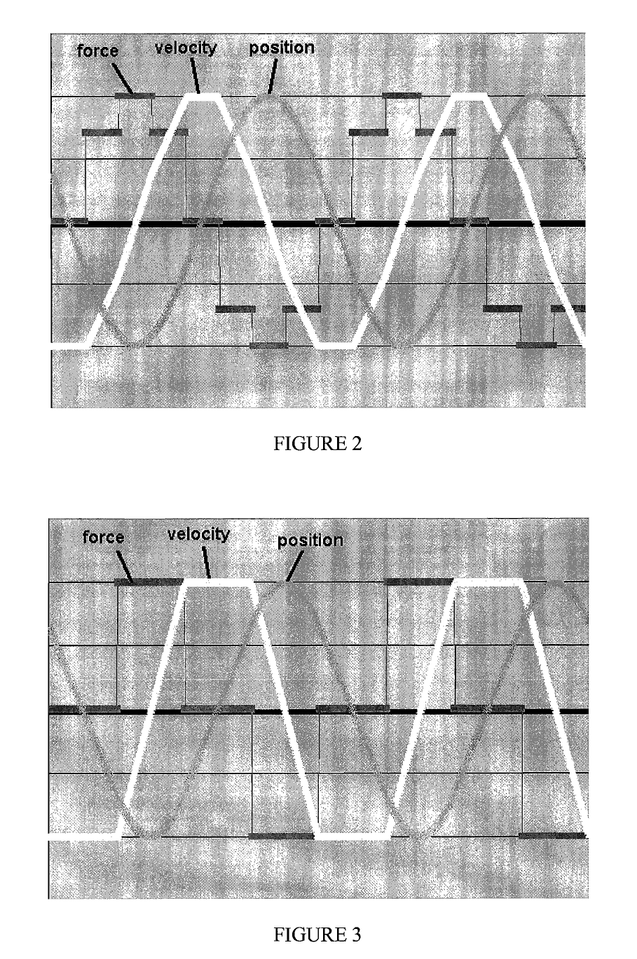

When the electric field for the square wave drive is incremented rotationally, the force (and thus acceleration) appears as shown in FIG. 2. This waveform is then integrated with respect to time to calculate the resulting ion velocity. A second numerical integration solves for position. It is clearly seen that the resulting ion-position waveform is very close to an ideal sine wave. Obviously, with more poles than the 8 in the octopole configuration, the force field approximation improves. However, even a minimal quadrapole configuration as used in the prior type of rotating electric field ion mass spectrometer (REFIMS) can attain reasonable results with the square wave drive. One caveat is that three voltages (force) are required, not just positive and negative, but zero as well. A simulation for the quadrapole configuration is shown in FIG. 3. The pseudo-sinewave trajectory can be generated with only a few percent distortion. Considering a full range of possible multipole electrode configurations and waveform integrations, the more general term “digital drive” can be used to refer to deflection drive waveforms generated digitally, as contrasted to analog (sine) waveforms.

In a related 3HMS design, described in my co-pending U.S. patent application ______, also incorporated herein by reference, a rotating electric field ion mass spectrometer has deflection electrodes formed as an array of blade elements arrayed radially and circumferentially about an ion axis of the mass spectrometer. A sufficient number of blades can be aligned orthogonally to form a horn shape to approximate the resultant electric field of using hyperbolic wall surfaces for the deflection electrodes. The digital deflection drive described herein can be used to drive a multi-pole array of such blade elements.

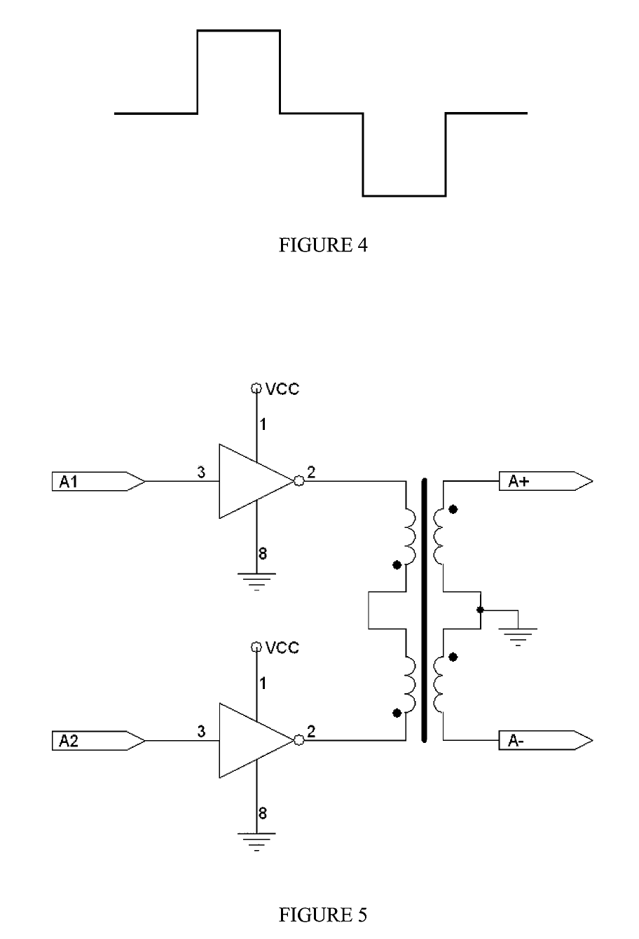

An example will now be given how to generate the appropriate RF voltages to provide a symmetric digital drive. The electric field must have three levels: push, pull, and null, thus requiring three voltage levels. Normalized, these are 0, +1, and −1. FIG. 4 illustrates schematically the output of a basic tri-level voltage drive. One solution for conversion to normal binary logic circuits is offered in FIG. 5. It uses a center-tapped secondary on a transformer for the two opposing outputs, A+ and A−. Using a transformer insures symmetric drive between opposing grids. It also has a low impedance dc path to ground for discharging colliding ions. Two high-powered logic gates drive the primary. If both gates are logic high, there is no voltage across the primary and the output voltage is zero. Same if both gates are logic low. Only when A1 and A2 are different is there an output voltage.

The following table defines the possible states for the output A+, corresponding to FIG. 4. This comprises a Gray code, such that only one gate switches at a time. It is also symmetric so that no DC flux exists on the transformer core. The transformer can also provide voltage gain via turn ratios.

| | 0 | +1 | 0 | −1 | 0 |
|---|---|---|---|---|---|
| A1 | L | H | H | L | L |
| A2 | L | L | H | H | L |

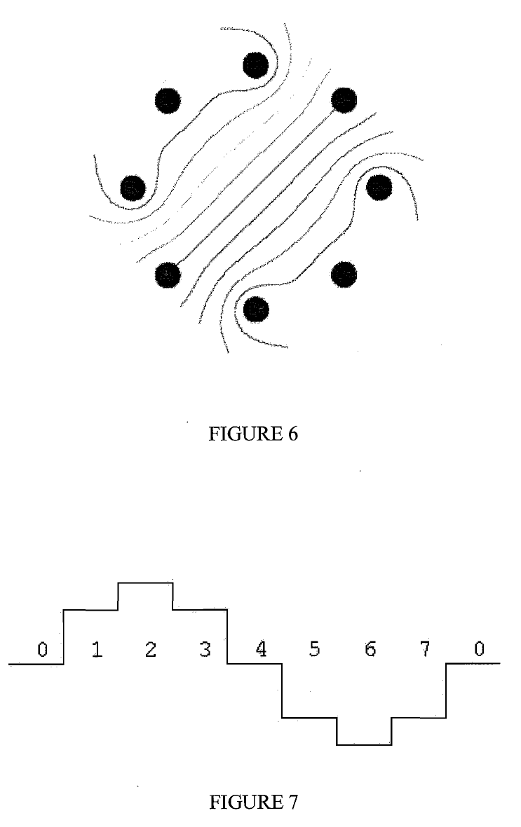

The tri-level output circuit in FIG. 5 drives just one pair of electrodes (a pair being 180 degrees apart). Therefore, an octopole would need four of these drive circuits, properly sequenced to generate an incrementally rotated electric field. FIG. 6 illustrates an octopole electrode arrangement as an example. FIG. 7 shows the field amplitude cycle along any given electrode axis for the octopole configuration, with the 8 sequenced states labeled zero through seven. The best field linearity is obtained (for an octopole) with three adjacent grids actively driven to +1 or −1, with the remaining two at zero. With a higher number of grids, this parameter can be adjusted as desired to achieve various field curvatures. The sequence for proper rotation of the octopole is given in the following table.

| | 0 | 1 | 2 | 3 | 4 | 5 | 6 | 7 |
|---|---|---|---|---|---|---|---|---|
| A | 0 | −1 | −1 | −1 | 0 | 1 | 1 | 1 |
| B | 1 | 0 | −1 | −1 | −1 | 0 | 1 | 1 |
| C | 1 | 1 | 0 | −1 | −1 | −1 | 0 | 1 |
| D | 1 | 1 | 1 | 0 | −1 | −1 | −1 | 0 |

The above octopole logic sequence is easily created by microprocessor, field programmable gate array (FPGA), or even simple logic circuits. It is important to note that the output rotational frequency is ⅛^{th} the system clock rate. Conversely, the system clock must be n times the desired rotation frequency, where n is the number of grids. This concept can be extended to any number of grid pairs.

One method to realize the logic sequence is to use a 3-bit binary counter that continually rolls over. It is clocked by a frequency 8 times the resulting output (for octopole example) and has output bits XYZ. The logic table can thus be written as follows.

| | X | Y | Z | A1 | A2 | B1 | B2 | C1 | C2 | D1 | D2 |
|---|---|---|---|---|---|---|---|---|---|---|---|
| 0 | 0 | 0 | 0 | 0 | 0 | 1 | 0 | 1 | 0 | 1 | 0 |
| 1 | 0 | 0 | 1 | 0 | 1 | 0 | 0 | 1 | 0 | 1 | 0 |
| 2 | 0 | 1 | 0 | 0 | 1 | 0 | 1 | 0 | 0 | 1 | 0 |
| 3 | 0 | 1 | 1 | 0 | 1 | 0 | 1 | 0 | 1 | 0 | 0 |
| 4 | 1 | 0 | 0 | 1 | 1 | 0 | 1 | 0 | 1 | 0 | 1 |
| 5 | 1 | 0 | 1 | 1 | 0 | 1 | 1 | 0 | 1 | 0 | 1 |
| 6 | 1 | 1 | 0 | 1 | 0 | 1 | 0 | 1 | 1 | 0 | 1 |
| 7 | 1 | 1 | 1 | 1 | 0 | 1 | 0 | 1 | 0 | 1 | 1 |

This can be rewritten with Karnaugh-style reduction minterms:
A1=X
A2=!XZ+!XY+X!Y!Z
B1=!X!Y!Z+XZ+XY
B2=!XY+X!Y
C1=!X!Y+XY
C2=!XYZ+X!Y+X!Z
D1=!X!Y+!X!Z+XYZ
D2=X

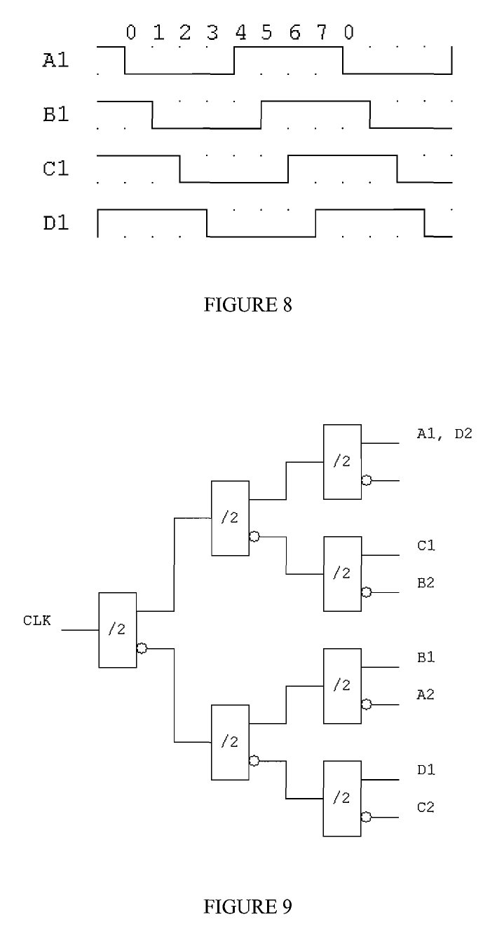

These equations can be programmed into an FPGA or other combinational logic device. Interestingly, by looking at the logic table, it can be seen that there is a repeating pattern and that A1 precedes B1 by 45 degrees, C1 by 90 degrees, and D1 by 135 degrees. This can be seen in FIG. 8 which illustrates the relationship between octopole phases.

Another approach to logic reduction is by using three levels of divide-by-two flip-flop stages. This is because 360 degrees divided by 8 is 45 degrees, and that 2³=8 (hence three levels). Such a circuit for three-state logic reduction is shown in FIG. 9. This is a very simple circuit to construct, and it performs both logic reduction and frequency division. This technique applies to any 2ⁿ system. Both A1 and D2 are equal, just as shown in the above minterms.

In summary, a novel square wave drive or digital drive can be readily implemented with simple and inexpensive circuitry for handling the ion beam input of a rotating electric field ion mass spectrometer (REFIMS), and specifically, a hyperbolic helical horn mass spectrometer (3HMS). The simplicity of the digital drive provides similar performance at a far lower cost, as compared to prior art circuitry based on analog sine waveforms.

It is understood that many modifications and variations may be devised given the above description of the principles of the invention. It is intended that all such modifications and variations be considered as within the spirit and scope of this invention, as defined in the following claims.

1. A rotating electric field ion mass spectrometer having a three-dimensional construction with an ion axis extending in a longitudinal direction and deflection electrodes forming a three-dimensional rotating electric field along the ion axis, wherein the deflector electrodes form a corresponding number of poles of the electric field in a multipole configuration and are driven by electronic drive circuitry that generates waveforms for the respective electrodes having a field amplitude cycle of digitally-generated levels equal to the number of poles.

2. A rotating electric field ion mass spectrometer according to claim 1, formed as a hyperbolic helical horn mass spectrometer having deflector electrodes arranged in a hyperbolic horn shape.

3. A rotating electric field ion mass spectrometer according to claim 1, wherein the number of poles is 8 in an octopole configuration of deflector electrodes.

4. A rotating electric field ion mass spectrometer according to claim 3, wherein the field amplitude cycle has flat voltage levels stepped in 45-degree phase increments.

5. A rotating electric field ion mass spectrometer according to claim 1, wherein the electronic drive circuitry is implemented by one of a group consisting of: a microprocessor, field programmable gate array (FPGA), and simple logic circuits.

6. A rotating electric field ion mass spectrometer according to claim 1, wherein the number of poles is 4 in a quadrapole configuration of deflector electrodes.

7. A hyperbolic helical horn mass spectrometer of the type having a three-dimensional hyperbolic horn construction of deflector electrodes extending in a longitudinal direction along an ion axis, wherein the deflector electrodes form a corresponding number of poles of the electric field in a multipole configuration and are driven by electronic drive circuitry that generates waveforms for the respective electrodes having a field amplitude cycle of digitally-generated levels equal to the number of poles.

8. A hyperbolic helical horn mass spectrometer according to claim 7, wherein the number of poles is 8 in an octopole configuration of deflector electrodes.

9. A hyperbolic helical horn mass spectrometer according to claim 8, wherein the field amplitude cycle has flat voltage levels stepped in 45-degree phase increments.

10. A hyperbolic helical horn mass spectrometer according to claim 7, wherein the electronic drive circuitry is implemented by one of a group consisting of: a microprocessor, field programmable gate array (FPGA), and logic circuits.

11. A hyperbolic helical horn mass spectrometer according to claim 7, wherein the electronic drive circuitry is implemented by logic circuits using three levels of divide-by-two flip-flop stages.

12. An electronic drive circuitry for multipole deflector electrodes of a rotating electric field ion mass spectrometer, wherein the deflector electrodes form a corresponding number of poles of an electric field to be generated in multipole configuration, said electronic drive circuitry being configured to generate waveforms for the respective electrodes having a field amplitude cycle of digitally-generated levels equal to the number of poles.

13. An electronic drive circuitry for multipole deflector electrodes of a rotating electric field ion mass spectrometer according to claim 12, wherein the number of poles is 8 in an octopole configuration of deflector electrodes.

14. An electronic drive circuitry for multipole deflector electrodes of a rotating electric field ion mass spectrometer according to claim 12, wherein the field amplitude cycle has flat voltage levels stepped in phase increments of 360 degrees divide by the number of poles.

15. An electronic drive circuitry for multipole deflector electrodes of a rotating electric field ion mass spectrometer according to claim 12, wherein the electronic drive circuitry is implemented by one of a group consisting of: a microprocessor, field programmable gate array (FPGA), and logic circuits.

16. An electronic drive circuitry for multipole deflector electrodes of a rotating electric field ion mass spectrometer according to claim 15, wherein the electronic drive circuitry is implemented by logic circuits using three levels of divide-by-two flip-flop stages.

17. An electronic drive circuitry for multipole deflector electrodes of a rotating electric field ion mass spectrometer according to claim 12, wherein the number of poles is 4 in a quadrapole configuration of deflector electrodes.

18. An electronic drive circuitry for multipole deflector electrodes of a rotating electric field ion mass spectrometer according to claim 17, wherein the electronic drive circuitry is a tri-level voltage drive implemented with binary logic circuits.
